(19) United States
(12) Patent Application Publication
(10) Pub. No.: US 2004/0073953 A1
(43) Pub. Date: Apr. 15, 2004

(54) Audio/video apparatus for use with a cable television network

(76) Inventors: Qi Xu, Santa Clara, CA (US); W. Leo Hoarty, Morgan Hill, CA (US); Gary M. Lauder, Atherton, CA (US)

Correspondence Address: John J. Stickevers, Bromberg & Sunstein LLP, 125 Summer Street, Boston, MA, 02110-1618, US

(21) Appl. No.: 10/603,586

(22) Filed: Jun. 25, 2003

Related U.S. Application Data
(63) Continuation-in-part of application No. 09/475,719, filed on Dec. 30, 1999.
Application No. 09/475,719 is a division of application No. 08/660,659, filed on Jun. 4, 1996, now Pat. No. 6,100,883.
Application No. 08/660,659 is a continuation of application No. 08/318,982, filed on Oct. 6, 1994, now Pat. No. 5,550,578.
Application No. 08/318,982 is a division of application No. 08/056,958, filed on May 3, 1993, now Pat. No. 5,526,034.
Application No. 08/056,958 is a continuation-in-part of application No. 07/754,932, filed on Sep. 10, 1991, now Pat. No. 5,220,420.
Application No. 07/754,932 is a continuation-in-part of application No. 07/589,205, filed on Sep. 28, 1990, now Pat. No. 5,093,718.
(60) Provisional application No. 60/391,298, filed on Jun. 25, 2002.

(51) Int. Cl. G06F 3/00; H04N 5/38; H04N 7/16; H04N 7/173; G06F 13/00; H04N 5/445; H04N 5/40

(52) U.S. Cl. 725/146; 725/47; 725/116; 725/117; 348/723; 348/724

(57) ABSTRACT

An apparatus for transmitting multimedia data to a set-top box for distribution to a headend of a cable television. The apparatus includes an input for a signal containing multimedia data. The apparatus has a module for compressing the multimedia data and also a packetizing module. The packetizing module adds a header. Since the headend is the only destination of the multimedia data, a destination address is unnecessary in the header, but the header does include an indicator as to source and an order identifier for each of the packets. The headend can then receive the packets, re-order the packets and decompress the multimedia data. The data may then be processed by a processor at the headend that is assigned at the beginning of an interactive session.

### CROSS REFERENCE TO RELATED APPLICATIONS

The following application claims priority from U.S. provisional patent application No. 60/391,298 entitled “Audio/Video Apparatus for use with a Cable Television Network filed on Jun. 25, 2002 and is a continuation in part of U.S. patent application Ser. No. 09/475,719 entitled “HOME INTERFACE CONTROLLER,” which was filed on Dec. 30, 1999. U.S. patent application Ser. No. 09/475,719 is a divisional of U.S. patent application Ser. No. 08/660,659, filed Jun. 4, 1996 which is a continuation of U.S. patent application Ser. No. 08/318,982, filed Oct. 6, 1994, which issued as U.S. Pat. No. 5,550,578, which is a divisional of U.S. patent application Ser. No. 08/056,958, filed May 3, 1993, which issued as U.S. Pat. No. 5,526,034, which is a continuation in part of U.S. patent application Ser. No. 08/877,325, filed May 1, 1992 which issued as U.S. Pat. No. 5,412,720, which is a continuation in part of U.S. patent application Ser. No. 07/754,932, filed Sep. 10, 1991, which issued as U.S. Pat. No. 5,220,420, which is a continuation in part of U.S. patent application Ser. No. 07/589,205, filed Sep. 28, 1990, which issued as U.S. Pat. No. 5,093,718 all of which are incorporated by reference herein in their entirety.

### TECHNICAL FIELD AND BACKGROUND ART

The present invention relates to audio and video capture devices and more specifically to audio and video capture device for use in a cable television network.

Video conferencing is well known within the prior art for two-way communication using both audio and video. Early video conferencing systems operated over phone lines. These early video conferencing systems employed special hardware to send and receive analog signals. Second generation systems continued to have specialized hardware, but switched to digital transmission and often employed an ISDN connection to provide sufficient bandwidth.

Newer video conferencing systems operate in the digital domain and take advantage of the increased processing power in personal computers and the expanded bandwidth of DSL and cable modem connections to eliminate specialized hardware. Such systems utilize the CPU and the video graphics card of the personal computer to perform the calculation intensive compression and synchronization of protocol based video conferencing that was previously performed by specialized hardware. Personal computer video conferencing systems communicate either through a peer to peer connection or via a third party.

With the advent of digital set-top boxes, cable television systems are rapidly performing more and more “computer-like” functions allowing cable television subscribers to access and view World Wide Web pages on their televisions. Although access to the web has been enabled, other “computer-like” functions, such as, video conferencing have not been available to cable television subscribers.

Additionally, cable television subscribers have lacked the ability to attach audio/video devices, such as cameras and CD-players, to the cable television network for the purpose of archiving multimedia data and exchanging information.

### SUMMARY OF THE INVENTION

An apparatus for transmitting multimedia data to a set-top box for distribution to a headend of a cable television is disclosed. The apparatus includes an input for a signal containing multimedia data. The apparatus has a module for compressing the multimedia data and also a packetizing module. The packetizing module adds a header. Since the headend is the only destination of the multimedia data, a destination address is unnecessary in the header, but the header does include an indicator as to source and an order identifier for each of the packets. The headend can then receive the packets, re-order the packets and decompress the multimedia data. The data may then be processed by a processor at the headend that is assigned at the beginning of an interactive session.

The apparatus may include a capture module which can be used for capturing analog data and converting it to a digital representation or for reformatting a digital representation, such as transforming color spaces from RGB to YUV for example. The apparatus may also include a demodulator in the capture module for receiving a modulated signal and separating the multimedia signal from the carrier wave. Further, the capture module can include an analog to digital converter for converting analog source signals to digital representations.

After the processing in the capture module, the multimedia data is passed to an encoder. During encoding, the multimedia data may be encoded using algorithms such as MPEG encoding. The packetization module may append a real time protocol header to each packet, such as an RTP header.

The apparatus may be coupled to a data port on a settop box. The settop box and the apparatus may be in two-way communication, such that the set-top box communicates with the apparatus to indicate when it is ready to receive data or the apparatus may issue an interrupt signal to the set-top box. The settop box provides the packetized and encoded multimedia data to the headend of a cable television network. A system's module at the headend forwards the data to the assigned processor.

The apparatus may be used to facilitate video conferencing in a cable television environment. An interactive session is selected by a cable television subscriber. The subscriber sends a signal through the use of a keyboard or remote control which is coupled to the set-top box wherein the signal indicates that a video conferencing session is desired. The headend assigns a processor to the interactive session and the processor begins to execute a video conferencing program. The processor then queries for a destination address through the settop box which is displayed on the display device coupled to the set-top box. The cable subscriber enters the destination address which is then sent to the headend and to the processor. The processor then indicates to the set-top box that the apparatus should begin transmission of data. The data is then processed by the apparatus. The apparatus encodes and packetizes the multimedia data and the data is passed to the set-top box that forwards the data to the headend for reordering decoding. The decoded data is passed to the processor and the multimedia data is encoded using video conferencing software. The processor then uses the previously sent destination address and forwards the processed multimedia data to the destination. The destination sends multimedia data to the headend that decompresses it and forwards the data to the set-top box for display on the cable television subscriber's display device without any further communication with the apparatus.

### BRIEF DESCRIPTION OF THE DRAWINGS

The foregoing features of the invention will be more readily understood by reference to the following detailed description, taken with reference to the accompanying drawings, in which:

FIG. 1 is an environment for implementing one embodiment of the present invention;

FIG. 2 is a block diagram that show the A/V apparatus;

FIG. 2A is another embodiment of the A/V apparatus wherein the apparatus provides inputs for both analog and digital signals;

FIG. 3 is a block diagram that shows the transmission path from the A/V input to a network such as the Internet;

FIG. 4A shows an input data stream and an output data stream of the capture module in which the input is digital video data;

FIG. 4B shows an input and an output data stream of the capture module in which the input data stream is an analog audio signal;

FIG. 5A shows an example of an input digital video signal and an output compressed digital video signal in an encoder;

FIG. 5B shows an input digital audio signal and an output compressed digital audio signal in an encoder;

FIG. 6 is a protocol sequence that is used by the packetizer module;

FIG. 6A shows a header and attached packets when MPEG compression is used in the encoder;

FIG. 7A and FIG. 7B show flow charts of the steps which are employed by the assigned processor at the headend of the cable television system;

FIG. 7A shows a flow chart in which the assigned processor reorders and decompresses the data which is received from the A/V device; and

FIG. 7B shows a flow chart in which the assigned processor receives a reordered and decompressed data; and

FIG. 7C schematically shows the functions performed during a video conferencing session.

### DETAILED DESCRIPTION OF SPECIFIC EMBODIMENTS

Definitions. As used in this description and the accompanying claims, the following terms shall have the meanings indicated, unless the context otherwise requires: the term “multi-media data” shall apply to both a combination of video, film or audio information and also to any individual source independently, such as, audio information.

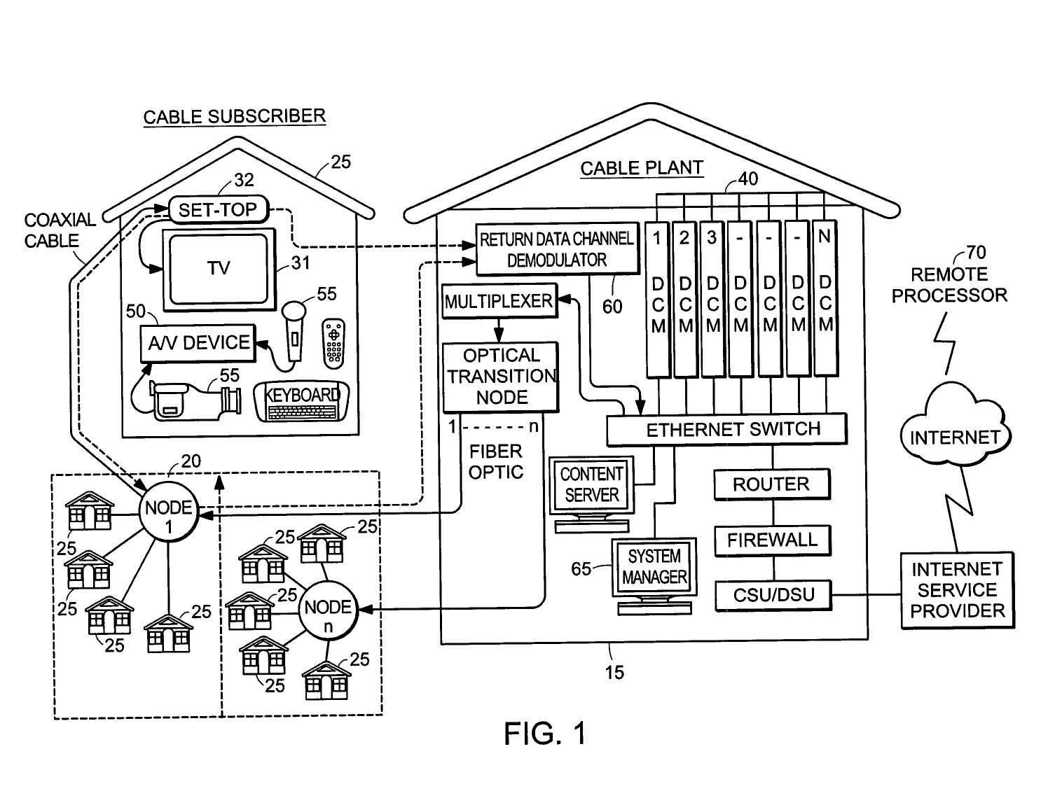

FIG. 1 is an environment for implementing one embodiment of the present invention. The environment 10 shows a cable television network having a headend 15 that distributes cable television signals to a plurality of nodes 20. Each node 20 is coupled to a plurality of cable subscribers' homes 25. The cable 30 from the node 20 to the cable subscriber's home 25 may be directly coupled to the cable subscriber's television 31 or to a set-top box 32 which is in turn coupled to the cable subscriber's television 31. The set-top box 32, which may be a digital or analog set-top box, is configured for two-way transmission of signals through a cable port. The cable television network as shown in FIG. 1 may be the same as that described in U.S. Pat. No. 6,100,883 which is incorporated by reference herein in its entirety.

At the headend 15 of the cable television network, a plurality of assignable processors 40 are provided which in FIG. 1 are labeled DCM. Each processor 40 is assignable to a cable subscriber's television 31 when an interactive activity is requested through the set-top box 32. The processors 40 at the headend provide general purpose processing and are capable of running software programs. The processors 40 may be those from Intel Corp., Apple, or AMD (American Micro Devices). Such processors are generally used for personal computers. The processors 40 may run various software, such as gaming software, internet browsers, video conferencing software, and audio compression and archiving software. The invention as embodied operates such that all general purpose processing occurs at the headend.

As shown in FIG. 1, an audio/video apparatus 50 is coupled to a set-top box. The audio/video (“A/V”) apparatus receives in input audio and video signals from audio and video devices 55 containing multimedia data. For example, a video camera or a microphone may be coupled to the A/V apparatus. The A/V apparatus processes the received signals so that the signals may be sent via the set-top box 32 through a return data channel demodulator 60 to an assigned processor at the headend of the cable television network. If a subscriber has requested an interactive session, the system manager 65 negotiates a connection with a DCM 40. If the requested interactive session is for video conferencing, the assigned processor/DCM 40 at the head end 15 accesses a video conferencing program from associated memory and negotiates a video conferencing session with a remote processor 70. Thus, the processor 40 at the head end 15 of the cable television network performs video conferencing protocol processing, such as the H.263, and routing of the video and audio information that would be associated with a local processor in a personal computer based video conferencing system.

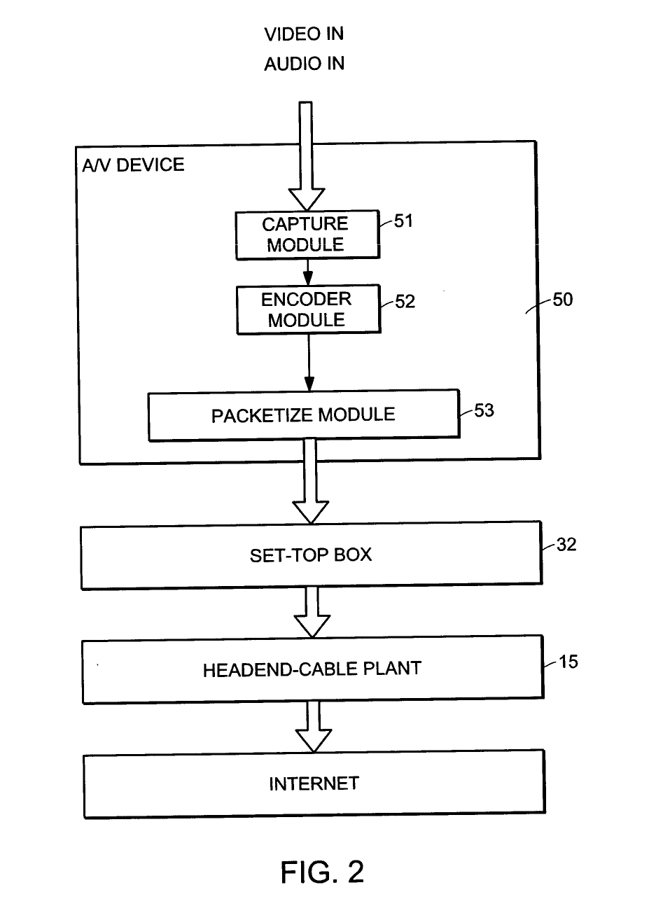

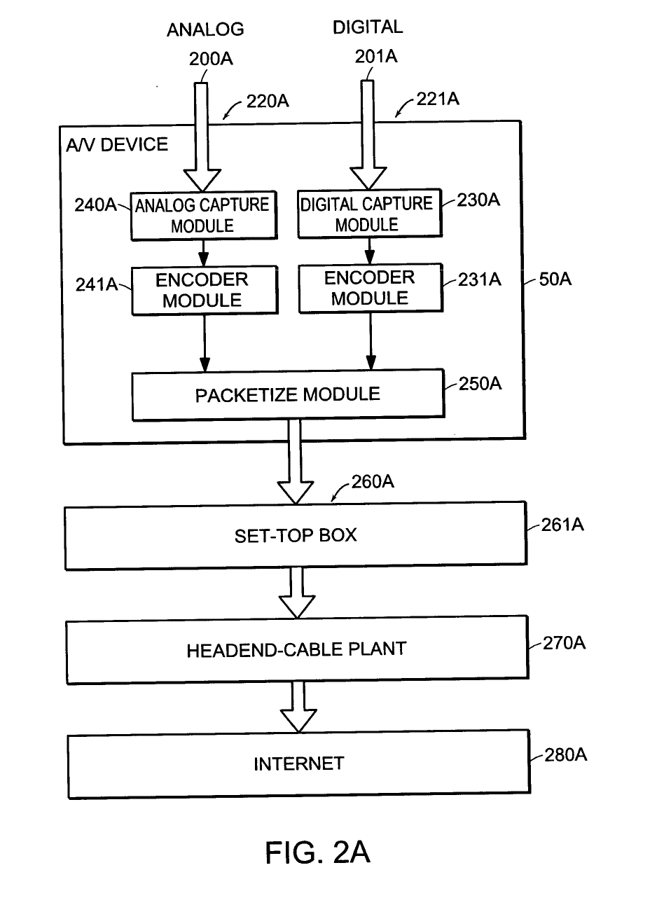

FIG. 2 is a block diagram showing the components of the A/V apparatus 50. The A/V apparatus 50 includes three modules: a capture module 51, an encoder 52 and a packetization module 53. The capture module 51 at least receives and buffers the input signal for the encoder. The capture module 51 may further demodulate a signal so that it can be digitized in an analog to digital converter (A/D) or digital data can be further processed and reformatted. The encoder 52 receives as input a digital representation of the input signal and compresses the signal. The compressed signal is then sent to the packetization module 53 which groups the compressed digital data into sections and appends one or more headers to the sectioned data so that the signal may be later reconstructed.

In another embodiment, the A/V apparatus 50A provides separate inputs for both analog and digital signals 200A, 201A as shown in FIG. 2A. In this embodiment, the A/V apparatus 50A provides a digital input 210A for capturing digital data such as digital video data from a charged coupled device (“CCD”) camera. The A/V apparatus 50A also has an analog input 220A for receiving an analog signal 200A, such as, an analog speech signal produced by a microphone. It should be understood by one of ordinary skill in the art that the A/V apparatus 50A may provide one or more inputs for analog, digital, or analog and digital signals. It should also be clear that the device could be configured to receive only an analog or digital signal. An electronic device such as a microphone, video camera, or video camcorder is coupled to either an analog or digital input of the A/V device dependent on the source material. The electronic device produces a signal which is received by the input port of the A/V apparatus. If the signal is composed of digital video data, such as from a CCD camera, the digital data would be passed to a digital capture module 230A and the digital values would be reformatted into a component color representation such as YUV or RGB. If the input signal is digital audio data, the data would simply be buffered and then passed to the encoder 231A. In one embodiment, the digital input port 210A provides for automatic sensing of the input data stream. In another embodiment, a switch selects the type of input digital data stream that provides for routing of the digital data stream to the appropriate capture module 230A, 240A. For example, as expressed above, a separate capture module for the A/V device may be provided for digital video as well as for digital audio wherein a switch would be set dependent upon the source. If the input signal is an analog audio signal, the analog capture module 240A provides an A/D converter for converting the analog signal into a series of discrete digital samples. The capture module 240A, 230A may further include a demodulator for demodulating either an analog multimedia signal or a digital multimedia signal that is received on a carrier wave. After the capture module has processed the data such that a digital output stream is produced, the digital data is passed to an encoder 241A.

The encoder 241A, 231A analyzes the digital data to compress the digital signal. If the digital signal is a video signal, the encoder will transform, quantify and entropy encode the data. Compression such as MPEG or H.263 compression may be used. If the digital data signal is audio, a G.728 or AC3 encoder may be employed. Other compression methods for audio and video may also be employed. It should be understood by one of ordinary skill in the art that there may be separate encoders for the analog originating signal and the digital origination signal or there may be one encoder which is shared by both. Further, it should be appreciated that there could be a digital audio input and a separate digital video input such that the encoder would perform the desired type of compression on the respective digital input signal.

From the encoder 231A, 241A, the digital signal is fed into a packetizing module 250A. The packetizing module 250A segments the compressed digital signal into packets of either a fixed or variable length. A header is app ended to each packet. In one embodiment, in which MPEG compression standard is employed for audio and video, the transport stream which is provided to the packetization module 250A is already in a packetized format in which the packet length is 188 bytes. In such an embodiment, a new header is placed on regrouped transport stream packets. The header in such an embodiment contains the format of a real-time transmission protocol such as RTP. Once the data is packetized, the data is sent to the set-top box data port through standard port negotiations.

The data port 260A of the set-top box 261A may be a serial port, but is preferably a USB port or other port providing a wide bandwidth throughput. The data port 260A allows the set-top box to receive an external signal that can then be sent on the return path to the headend 270A. The set-top box 261A then receives the packetized data and modulates the packets onto a carrier frequency for transmission to the head end 270A through the return path of the cable network. It should be understood that the A/V device does not modulate the signal, but only provides a conduit for the data into the cable television network. The signal is then passed to the headend.

At the headend 270A of the cable television network the signal may undergo additional processing if, for example, the selected interactive service is video conferencing. If however, the selected interactive service is archiving of digital images or digital audio the signal may be directed to a memory location at the headend 270A. The headend in turn may be connected to the Internet 280A for facilitating video conferencing, or for remote storage of multimedia data from the A/V device 50A.

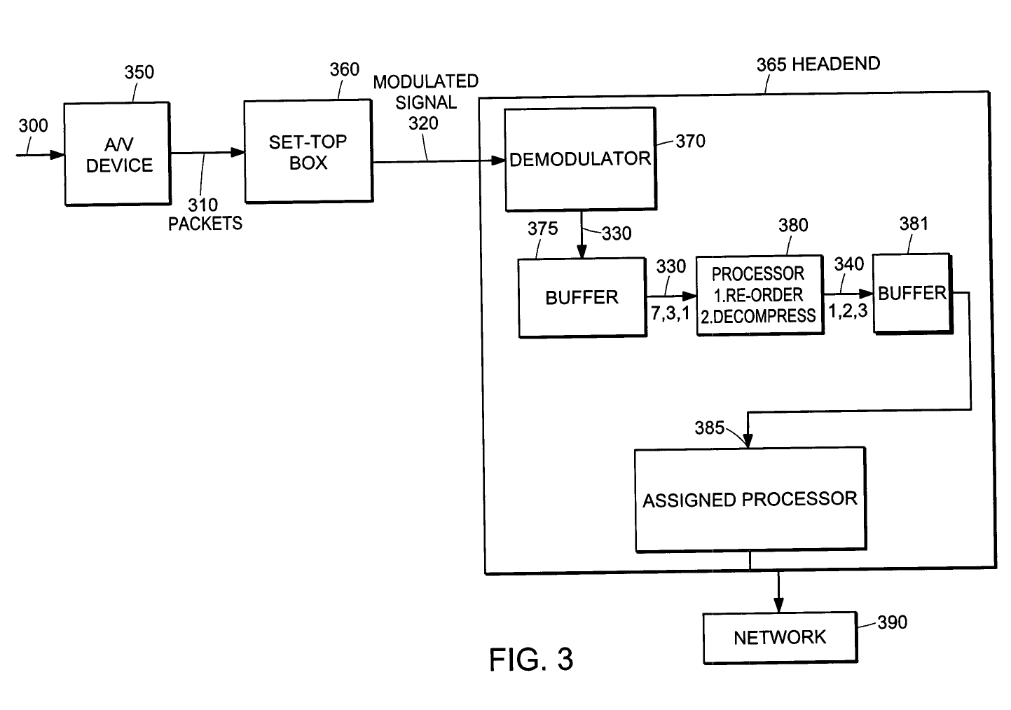

FIG. 3 is a block diagram that shows the transmission path from the A/V input 351 to a network such as the Internet 390. The originating multimedia data 300 passes through the A/V apparatus 350 that provides the packetized data 310 to the cable system through the set-top box 360. The A/V device sends an interrupt signal to the set-top box to indicate that data is ready to be transmitted. The set-top box responds by receiving the digital packetized data into the data port and then modulates the data onto a carrier signal. The set-top box transmits the signal into the cable network where the modulated signal 320 is received at the headend 365. The headend 365 demodulates the signal in a demodulator 370 and the digital packetized data 330 is placed into a buffer 375. The digital packetized data 330 is retrieved from the buffer 375 by a processor 380 for reconstructing the multimedia signal. Prior to implementing any further processing or addressing the digital packetized data to a destination address, the processor analyzes the information in the header, which may be a RTP header, and with associated memory reconstructs the data signal by stripping away the header and reordering the packets of digital data. The digital data is then decompressed according to the compression algorithm that was employed in the A/V device. After decompression, the digital data 340 is buffered in a buffer 381 and may be sent to an assigned processor 385 for implementing the requested interactive service. It should be understood that reconstruction of the digital multimedia data may be achieved in the assigned processor or may be performed in a separate processor as shown.

If for example, the cable subscriber selects video conferencing as the interactive service and transmits that selection signal to the headend through the set-top box using a remote control or keyboard, the subscriber would be queried on the subscriber's television by the assigned processor at the headend regarding the destination of the video transmission. Depending on the video conferencing software that is run on the assigned processor, the destination address may be designated by an e-mail address or an IP address for example. The subscriber enters the destination address using either a remote control or keyboard which is coupled to the set-top box.

Once a destination is entered and transmitted by the cable television subscriber, the system manager or the assigned processor 385 stores this information in associated memory for later retrieval of the information. Video and audio information is then transmitted from the camera and microphone attached to the A/V device and compressed and packetized in the A/V device and then sent to the headend through the set-top box.

At the headend, the information is reconstructed and then decompressed. A driver program resident at the headend receives the reconstructed data and then provides the information to the assigned processor running the video conferencing software, as if the input video information were provided through a local input port (such as a parallel port or USB port of a personal computer). The video conferencing software applies well known video conferencing techniques to the decompressed digital video and audio data in anticipation of transmission.

For example, the video conferencing software would implement one of the standard video conferencing protocols such as H.323, although other video conferencing protocols may be used and as such the video would again be compressed and packetized adding an H.323 header. The video conferencing software also retrieves the destination address, which was previously stored in memory. Handshaking between the destination and the headend ensues until a virtual connection is made for streaming the video and audio information in both directions.

The video and audio from the destination which is received at the headend would be routed to the assigned processor which performs the inverse video conferencing protocol requiring the stripping away of the protocol headers and decompressing the audio and video data. The processor then either passes the digital audio and video data to another processor for compression and transmission to the set-top box or performs the compression itself. The headend sends the compressed digital audio data to the set-top box either based upon an address associated with the set-top box which was passed to the headend upon establishment of the interactive session or based upon the origination information that was provided in the header of the packetized compress digital data from the A/V device. The above description assumes the set-top box within the cable television system includes a decoder. It should be understood by one of ordinary skill in the art that the multimedia data received from the destination once decompressed by the video conferencing software may be sent to the display of the cable television subscriber without being recompressed if the cable television system is configured to do so.

It should be understood that the destination compressed digital audio and video information is decompressed within the set-top box, which outputs the audio and video to the subscriber's television. The destination address may be within the cable television network (having a network address) or may be an internet protocol (“IP”) address. If the destination address is an IP address that is external to the cable television network, the processor would be either directly or indirectly coupled to the Internet.

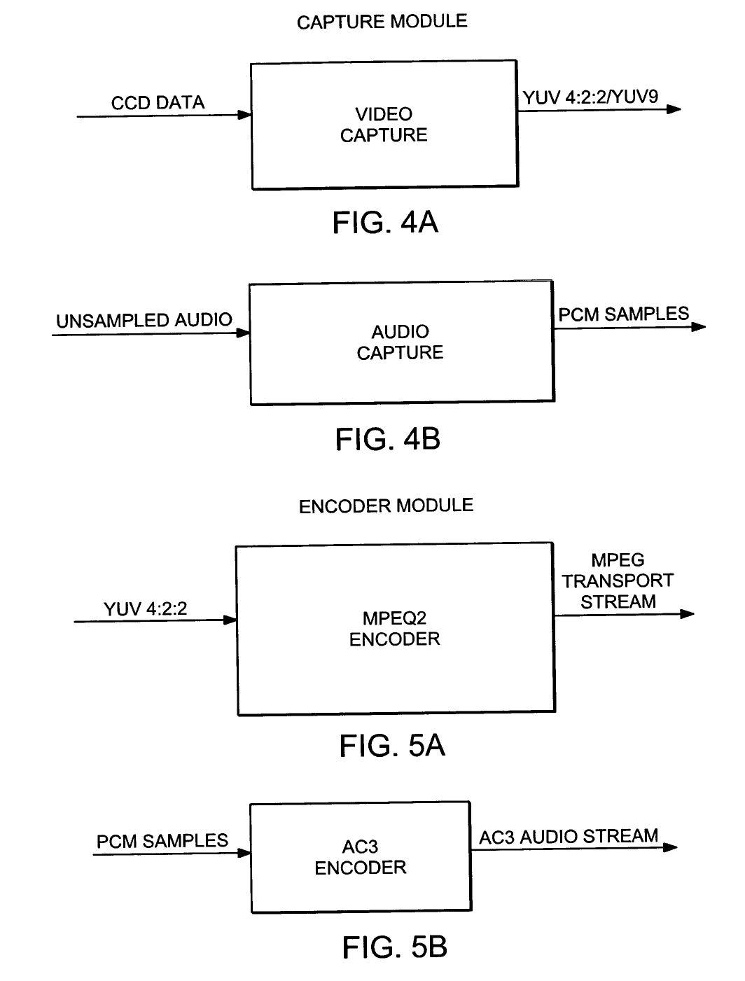

FIG. 4A shows the input data stream and the output data stream of the video capture component. In this embodiment raw CCD data is input and YUV 4:2:2 data is output. FIG. 4B shows an analog unsampled voice signal input into the audio capture component. In one embodiment the capture module has a video capture component and an audio capture component. The video and audio may be input through two ports or through a single port such as an IEEE1394 or USB port. The output of the audio capture component is pulse code modulated samples, sampled at such frequencies as 48 KHz, 44.1 KHz, 32 KHz, 24 KHz, 16 KHz, or 12 KHz.

FIG. 5A shows a video encoder in which the YUV 4:2:2 data is input while an MPEG stream is output. Inside the video encoder an MPEG-2 algorithm is implemented. In one embodiment, an IBM MPEGS420 Encoder is used to implement MPEG-2 compression. Other compression techniques that could be used include, but are not limited to MPEG-4 or MPEG-7 encoding. The input signal of the audio encoder of FIG. 5B is PCM samples wherein AC3 encoding is performed on the PCM samples within the audio encoder. The output stream is an AC3 encoded audio stream. In such an embodiment, a Motorola 56301 DSP audio encoding chip could be used. As with the video encoder, other compression techniques may be employed including MPEG-1 level 3 encoding (MP3), G.711, G.722, G.723, G.728, and G.729.

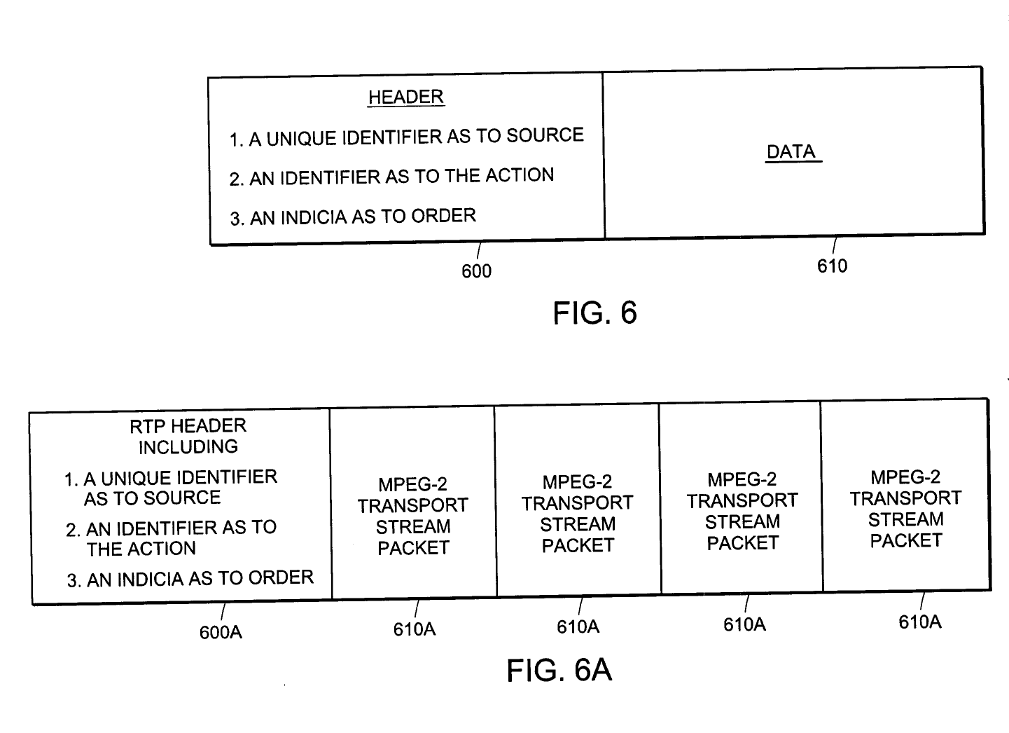

FIG. 6 is a protocol sequence that is used by the packetizer module. The output of the encoder which is a compressed stream of data is segmented into packets and a header 600 is added which contains a unique identifier as to source, such as the set-top box identification number. The header further includes an identifier as to the action, such as a time and date for beginning a video conferencing session. The header also includes an indicia as to order, for example that the packet is the second packet in the video conferencing data stream. By providing this information in the header, the packets of data 610 can be released into a packet-based digital cable network having a sole destination that is the headend or the packets can be modulated on a radio-frequency signal for sending to the headend. In either embodiment, the signal can be retrieved at the headend where the packets can be stored in a buffer and then reordered and decompressed.

In one embodiment as shown in FIG. 6A, video packets which are the result of the encoder are reformatted. For example, multiple MPEG-2 transport stream packets 610A are encapsulated within a single RTP packet for transmission. The RTP protocol includes the payload type, the sequence number and the timestamp. In the RTP header 600A, the payload type would include the type of information being sent to the headend and also the originator of the material. In one embodiment, this identifier as to origination is a virtual IP address which is associated with the set-top box of the cable subscriber. The headend which has an actual IP address uses the virtual IP address to identify the set-top box sending the information. The virtual IP address may be assigned to the set-top box at the beginning of an interactive session or may be permanently assigned to a set-top box. By attaching this RTP header information in the packetizer module, the data may be reconstructed and therefore the A/V device appears to the processor at the head end as if the A/V device is virtually attached. In an alternative embodiment, the headend may not reconstruct the original data stream and instead provide the packets to the assigned processor that is running the appropriate software, for example the video conferencing software. In such an embodiment, the video conferencing software would be configured to receive and recognize the header information of the data packets.

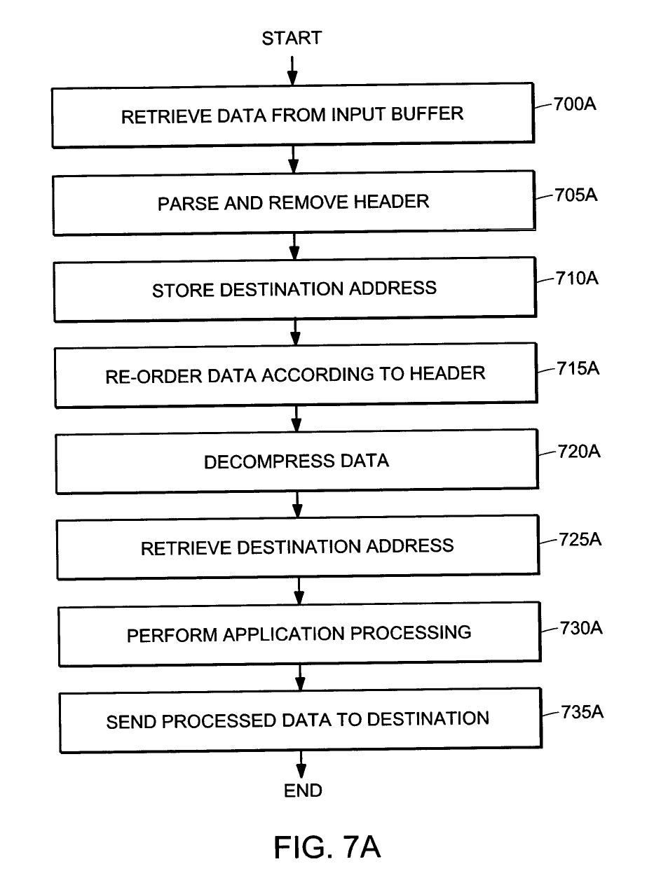

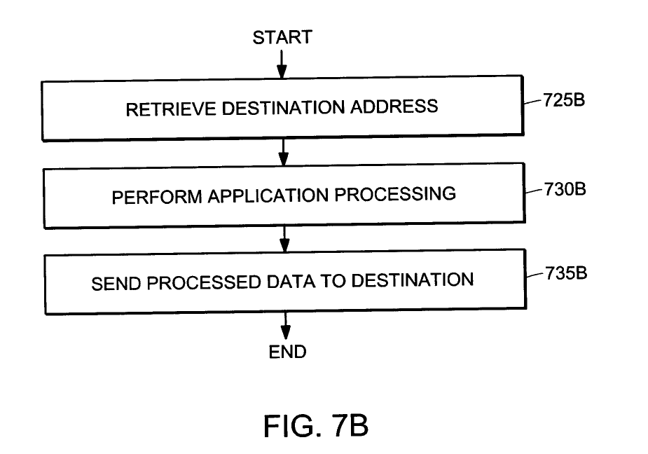

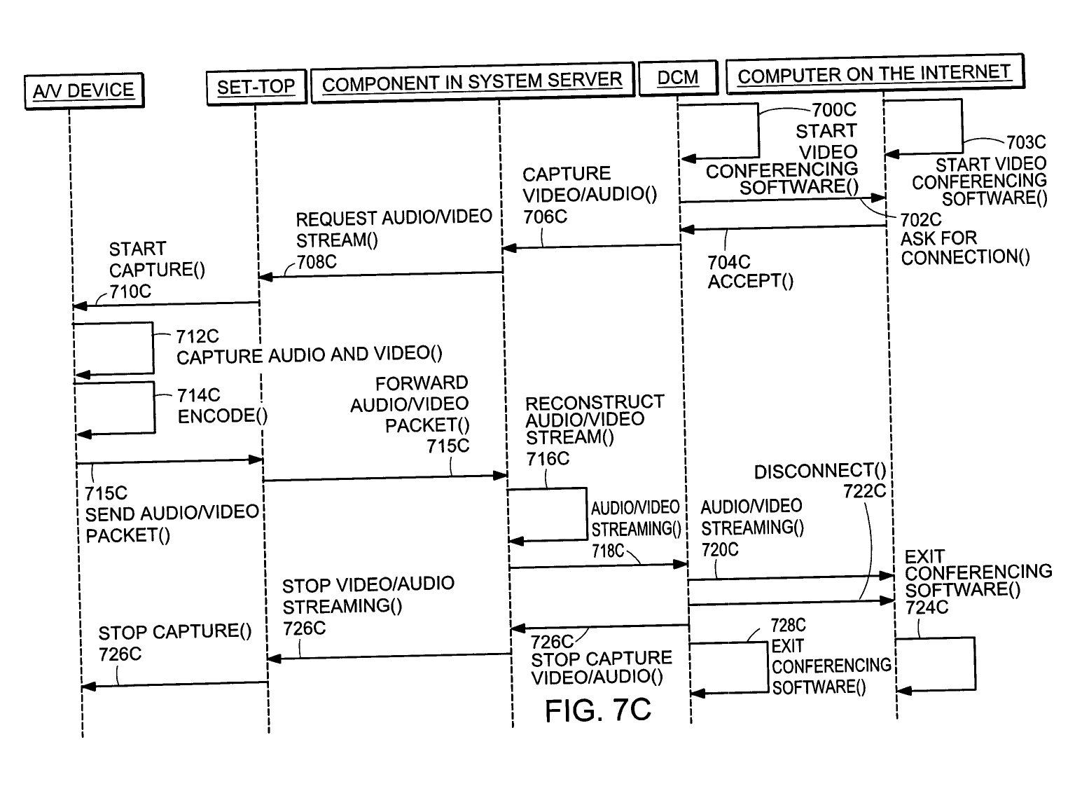

FIG. 7A and FIG. 7B show flow charts of the steps which are employed at the headend. FIG. 7A shows the steps which occur in the processor if the data stream is already reconstructed and stored in a buffer while FIG. 7B shows the steps that occur in the processor if the data stream is not already reconstructed.

Turning to FIG. 7A, first, the destination address is passed to the headend through the set-top box and stored in memory. Data is then retrieved from an input buffer 700A. As the data is received the processor parses and removes the header 705A. The destination address is stored 710A. The processor then reorders the data according to the header information 715A. As the packets of digital data are placed in order, the data may be stored in memory or temporarily stored in a buffer. The data is then decompressed using the inverse algorithm that was used to compress the data in the A/V device 720A. At this point, the destination address is retrieved and the assigned processor initiates any program that is necessary for the processing of the data 725A. For example, in a video conferencing interactive session, a video conferencing software program would be initialized by the processor. A driver

that is associated with the video conferencing software would then obtain the destination address and begin to receive the decompressed data for video conferencing processing. The use of a virtual driver enables off-the-shelf video conferencing software to be employed. As the data is processed, it is passed to an output and on to its destination. Similarly, if an audio stream or video image was to be archived, the processor would access the destination for storing the data which may be a preassigned memory location. The processor then performs any further processing such as compression on the data to maximize the storage capacity 730A. The data is then sent to the designated memory location 735A.

In FIG. 7B, the processor does not perform the steps of parsing the digital data, reordering the digital data and decompressing the digital data. These steps are performed by a second processor which may be the system manager. In this embodiment, the processor performs simply the functions that a home video conferencing personal computer would perform. The processor receives a destination address and then initiates a connection with a processor at the destination 725B. The processor then perform the requisite processing for the chosen application of the interactive session utilizing the virtual driver for accessing the buffered data 730B. The data is then forwarded to the destination address 735B.

FIG. 7C schematically shows the functions performed in each component within the cable television network after a request for a video conferencing session has been established. Once a processor/DCM has been selected video conferencing software is begun on the DCM 700C. The video conferencing software attempts to make a connection with video conferencing software at a destination based upon a received destination address from the set-top box 702C. The destination computer which is running its own video conferencing software 703C ccepts/rejects the connection 704C. If the destination computer accepts, the processor informs the system server that the audio/video capture should begin 706C. The server than sends a request to the set-top box 708C. The set-top box, through the input port sends a start capture signal to the A/V device 710C. In response, the A/V device begins capturing audio and video 712C, and encodes and packetizes the audio and video 714C. The packets are then forwarded to the system server 715C that then reconstructs the compressed audio/video stream 716C. The audio/video stream is passed to the processor which receives the audio and video stream, processes it employing the video conferencing software to append a video conferencing header that is readable by the destination address and then sends the processed audio and video stream to the destination address 718C, 720C. This process continues until one of the two parties to the video conference ends the session. For example, as shown in FIG. 7C, the processor/DCM indicates to the destination address, through a disconnect signal, that the session should be ended 722C. The video conferencing software at the destination may then be stopped and shut down 724C. The processor also transmits a stop capture command to the system server which relays the message to the set-top box which in turn issues a signal to the A/V device to halt capture 726C. The processor also begins to exit the video conferencing software that it has been running 728C.

It should be understood that the A/V device may receive as input audio data such as that from a compact disk and pass this data in compressed form to the set-top box which modulates the compressed packetized data and provides this data to a processor on the headend. In such an embodiment, either the compressed data, which may be in MP3 format (MPEG-1 Layer 3) or raw PCM audio sampling data may be stored in memory associated with the processor for later retrieval by the processor for playback at the television set of the cable television subscriber. In such an embodiment, if the audio data was in a compressed format it will be streamed back to set-top box which would then decompress the stream using MP3 decompression and perform a D/A conversion if the television had only analog inputs or would provide the digital data directly to the television.

In another embodiment, the A/V device may be connected to a cable modem that communicates downstream to a processor at the headend of the cable television network. The processor may be utilized by the cable modem user. In such an embodiment, the system functions much as that described above wherein the processing power is remote from the A/V device and the A/V device provides a conduit for the transmission of audio and video data to the processor which is located at the cable headend. In a further variation, the A/V device might be included in a system which employs an interactive touch screen pad, having minimal processing capabilities, such as, a touch screen pad, as described in Provisional Patent Application entitled “Interactive Touchscreen Pad” which has Serial No. 60/347,033 and was filed Jan. 9, 2002 which is incorporated by reference herein in its entirety. In such a configuration, the A/V device might be connected to the touchscreen pad which would wirelessly transmit to a remote processor the compressed and packetized multi-media data. The touch screen pad could be provided with a port into which the A/V device would fit and to which a camera and microphone could be coupled for video conferencing purposes. Similarly the A/V device might be coupled to the remote processor or set-top box since the A/V device only provides input for video conferencing purposes.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. An apparatus for transmitting multimedia data to a set-top box for distribution to a headend of a cable television, the apparatus comprising:
means for inputting a signal containing multimedia data;
means for compressing the multimedia data;
means, for packetizing the compressed multimedia data with a header including at least a source identifier and an order identifier; and
means for outputting the packetized multimedia data to a data port of a set-top box,
further comprising capture means for capturing the input signal containing multimedia data.

2. The apparatus according to claim 1, wherein the capture means is an analog to digital converter.

3. The apparatus according to claim 1, wherein the capture means changes the format of the signal.

4. The apparatus according to claim 1, wherein the means for compression performs MPEG encoding.

5. An apparatus for facilitating video conferencing for use with a cable television network having a headend, the apparatus comprising:
an input for receiving a signal having multimedia data;
a demodulator for demodulating the signal;
an analog to digital converter for digitizing the multimedia data;
an output module for facilitating the transport of the digitized multimedia data to the headend.

6. An apparatus according to claim 5, further comprising:
an encoder operably coupled to the output module for compressing the digitized multimedia data prior to receipt by the headend.

7. 7. An apparatus for receiving a multimedia data signal and transmitting a compressed digital signal to a set-top box of a cable television network, the apparatus comprising:
an input for receiving the multimedia data signal;
a capture module for formatting the multimedia data signal creating a formatted digital signal;
an encoder for compressing the formatted digital signal creating a compressed digital signal;
a packetization module for packetizing the compressed digital signal and including a header identifying packet order and source; and
an output capable of being operably coupled to the set-top box for transmitting the packets to a headend of the cable television network.

8. The apparatus according to claim 7, wherein the packetizing module attaches a real time protocol header to each packet.

9. The apparatus according to claim 7, wherein the multimedia data signal is raw data from a charged coupled device.

10. The apparatus according to claim 7, wherein the capture module formats the multimedia data signal into a standard YUV format.

11. The apparatus according to claim 7 wherein the encoder employs MPEG compression algorithms.

12. The apparatus according to claim 7 wherein the packetization module packetizes the signal according to a real-time protocol.

13. The apparatus according to claim 7 wherein the real-time protocol is RTP.

14. A system for multi-media transmission of data in a cable television network, the system for multi-media transmission comprising:
a multimedia device; and
a set-top box
wherein the multimedia device has an input port for receiving a multimedia signal and an output port for sending to the set-top box a packetized compressed digital representation of the multimedia signal;
wherein the set-top box receives the packetized compressed digital representation of the multimedia signal and forwards the signal to a headend of the cable television network.

15. The system according to claim 14, wherein the multimedia device packetizes the multimedia signal wherein the header information of each packet only includes a source identifier and an order identifier.

16. The system according to claim 15 wherein the multimedia device further includes an action identifier for indicating an interactive session type.

17. The system according to claim 15 wherein the set-top box receives an interrupt from the multimedia device prior to receiving the multimedia signal.

18. The system according to claim 15 wherein the set-top box does not add header information prior to sending the multimedia signal.

19. A system for multimedia transmission of data in a cable television network, the system comprising:
a set-top box having a data port and a two-way communication cable port;
a multimedia device for receiving multimedia data signal and providing to the data port of the set-top box a compressed packetized multimedia data signal;
a headend operably coupled to the cable port of the set-top box for receiving, processing, and forwarding to a destination at least the multimedia data contained within the compressed packetized multimedia data signal.

20. The system according to claim 19, wherein based upon an input signal to the set-top box an interactive session is effectuated between the set-top box and the headend.

21. The system according to claim 20, wherein the interactive session may be video conferencing.

22. The system according to claim 21, wherein the headend receives destination multimedia data in a signal from the destination, the headend directs the destination multimedia data to the set-top box wherein the destination multimedia data is decompressed and provided to a television for display.

23. The system according to claim 19, wherein the multimedia device packetizes the multimedia data signal with a header containing a set-top box identifier and packet order identifier.

24. The system according to claim 23 wherein the destination multimedia data is sent to the set-top box based upon the set-top box identifier in the multimedia data signal.

25. The system according to claim 23 wherein the headend receives a destination address for the compressed packetized multimedia data signal originating at the set-top box.

26. The apparatus according to claim 6, further comprising a packetizer which creates packets from the compressed digitized multimedia data, wherein the packets do not provide a destination address and include origination information.

27. The apparatus according to claim 7 wherein the packetization module includes a header to each packet which does not include a destination address.

28. The system according to claim 14 wherein the multimedia device packetizes the multimedia signal wherein the header information does not include a destination address.
